(19) United States
(12) Patent Application Publication
(10) Pub. No.: US 2013/0203934 A1
(43) Pub. Date: Aug. 8, 2013

(54) TWO-COMPONENT, POLYASPARTIC COATING COMPOSITIONS

(71) Applicants: Kurt E. Best, Sewickley, PA (US); John P. Forsythe, Allison Park, PA (US); Joseph R. Kleer, Crescent, PA (US); Michael K. Jeffries, Follansbee, WV (US)

(72) Inventors: Kurt E. Best, Sewickley, PA (US); John P. Forsythe, Allison Park, PA (US); Joseph R. Kleer, Crescent, PA (US); Michael K. Jeffries, Follansbee, WV (US)

(73) Assignee: Bayer MaterialScience LLC, Pittsburgh, PA (US)

(21) Appl. No.: 13/639,923

(22) PCT Filed: Apr. 5, 2011
(86) PCT No.: PCT/US11/00609

§ 371 Date: Apr. 11, 2013

Related U.S. Application Data
(60) Provisional application No. 61/322,421, filed on Apr. 9, 2010.

(51) Int. Cl. C09D 175/02

(52) U.S. Cl. CPC C09D 175/02
USPC 524/589; 427/388.1; 427/385.5

(57) ABSTRACT

A polyurea coating composition comprising the reaction product of:
an isocyanate-functional component (A) comprising:
   a) an aliphatic isocyanate functional material; and
   b) a cycloaliphatic isocyanate functional material; and
an isocyanate-reactive component (B) comprising at least one polyaspartic acid ester component.

### BACKGROUND

Compositions based on isocyanate chemistry find utility as components in coatings, such as, for example, paints, primers, and the like. Isocyanate-based coating compositions may include, for example, polyurethane or polyurea coatings formed from resins comprising components, such as, for example, diisocyanates, polyisocyanates, and/or isocyanate reaction products. These resins may cure by various mechanisms so that covalent bonds form between the resin components, thereby producing a cross-linked polymer network.

Direct-to-metal ambient rapid-cure coatings with good adhesion and performance characteristics have always been a challenge in the coatings industry. The high throughput rates combined with cure speed is of paramount importance for a metal coater to get the parts done in a fast and timely manner.

Polyurea coatings based on polyaspartic acid esters have been used with much success. One issue with such coatings, however, is providing a coating composition which cures at an acceptable rate, and exhibits good adhesion to a metal substrate. The object of the present invention is to provide a coatings process that can meet the above described challenge.

### SUMMARY

In one embodiment, the present invention is directed to a polyurea coating composition comprising the reaction product of:

an isocyanate-functional component (A) comprising:
a) an aliphatic isocyanate functional material; and
b) a cycloaliphatic isocyanate functional material; and

an isocyanate-reactive component (B) comprising at least one polyaspartic acid ester component.

In an alternate embodiment, the present invention is directed to a polyurea coating composition consisting essentially of the reaction product of:

an isocyanate-functional component (A) comprising:
a) an aliphatic isocyanate functional material; and
b) a cycloaliphatic isocyanate functional material; and

an isocyanate-reactive component (B) comprising at least one polyaspartic acid ester component.

In an alternate embodiment, the present invention is directed to a polyurea coating composition consisting of the reaction product of:

an isocyanate-functional component (A) comprising:
a) an aliphatic isocyanate functional material; and
b) a cycloaliphatic isocyanate functional material; and

an isocyanate-reactive component (B) comprising at least one polyaspartic acid ester component.

It is understood that the invention is not limited to the embodiments disclosed in this Summary. The invention is intended to cover modifications that are within the scope of the invention as defined solely by the claims.

### DETAILED DESCRIPTION

It is to be understood that certain descriptions of the disclosed embodiments have been simplified to illustrate only those elements, features and aspects that are relevant to a clear understanding of the disclosed embodiments, while eliminating, for purposes of clarity, other elements, features and aspects. Persons having ordinary skill in the art, upon considering the present description of the disclosed embodiments, will recognize that other elements and/or features may be desirable in a particular implementation or application of the disclosed embodiments. However, because such other elements and/or features may be readily ascertained by persons having ordinary skill upon considering the present description of the disclosed embodiments, and are not necessary for a complete understanding of the disclosed embodiments, a description of such elements and/or features is not provided herein. As such, it is to be understood that the description set forth herein is merely exemplary and illustrative of the disclosed embodiments and is not intended to limit the scope of the invention as defined solely by the claims.

In the present disclosure, including the claims, other than where otherwise indicated, all numbers expressing quantities or characteristics are to be understood as being prefaced and modified in all instances by the term “about.” Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Any maximum numerical limitation recited herein is intended to include all lower numerical limitations subsumed therein and any minimum numerical limitation recited herein is intended to include all higher numerical limitations subsumed therein. Accordingly, Applicant(s) reserves the right to amend the present disclosure, including the claims, to expressly recite any sub-range subsumed within the ranges expressly recited herein. All such ranges are intended to be inherently disclosed herein such that amending to expressly recite any such sub-ranges would comply with the requirements of 35 U.S.C. §112, first paragraph, and 35 U.S.C. §132(a).

The grammatical articles “one,” “a,” “an,” and “the,” as used herein, are intended to include “at least one” or “one or more,” unless otherwise indicated. Thus, the articles are used herein to refer to one or more than one (i.e., to at least one) of the grammatical objects of the article. By way of example, “a component” means one or more components, and thus, possibly, more than one component is contemplated and may be employed or used.

Any patent, publication, or other disclosure material, in whole or in part, that is said to be incorporated by reference herein, is incorporated herein in its entirety, but only to the extent that the incorporated material does not conflict with existing definitions, statements, or other disclosure material expressly set forth in this disclosure. As such, and to the extent necessary, the express disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure of the compounds. As used herein, the term “cycloaliphatic” refers to organic compounds characterized by arrangement of carbon atoms in closed ring structures. Cycloaliphatic compounds do not contain aromatic rings as part of the molecular structure of the compounds. Hence, cycloaliphatic compounds are a subset of aliphatic compounds. Accordingly, an aliphatic composition may comprise an aliphatic compound and/or a cycloaliphatic compound.

As used herein the term “diisocyanate” refers to a compound containing two isocyanate groups. As used herein the term “polyisocyanate” refers to a compound containing two or more isocyanate groups. Hence, diisocyanates are a subset of polyisocyanates.

The isocyanate component (A) may comprise a combination of an aliphatic isocyanate functional material and a cycloaliphatic isocyanate functional material. The aliphatic isocyanate functional material may comprise a reaction product of an aliphatic diisocyanate and a hydroxy-functional ether compound. The cycloaliphatic isocyanate functional material may comprise a reaction product of a cycloaliphatic diisocyanate and a mono-functional alcohol compound. The aliphatic isocyanate functional material and the cycloaliphatic isocyanate functional material may each comprise at least one functional group selected from the group consisting of isocyanurate, iminooxadiazine, uretdione, allophanate, biuret, and combinations of any thereof. The aliphatic and cycloaliphatic isocyanate functional materials may be produced from and/or comprise polyisocyanates having an isocyanate functionality greater than 2.

Isocyanurates may be prepared by the cyclic trimerization of polyisocyanates. Trimerization may be performed, for example, by reacting three (3) equivalents of a polyisocyanate to produce 1 equivalent of isocyanurate ring. The three (3) equivalents of polyisocyanate may comprise three (3) equivalents of the same polyisocyanate compound, or various mixtures of two (2) or three (3) different polyisocyanate compounds. Compounds, such as, for example, phosphines, Mannich bases and tertiary amines, such as, for example, 1,4-diaza-bicyclo[2.2.2]octane, dialkyl piperazines, and the like, may be used as trimerization catalysts. Iminooxadiazines may be prepared by the asymmetric cyclic trimerization of polyisocyanates. Uretdiones may be prepared by the dimerization of a polyisocyanate. Allophanates may be prepared by the reaction of a polyisocyanate with a urethane. Biurets may be prepared via the addition of a small amount of water to two equivalents of polyisocyanate and reacting at slightly elevated temperature in the presence of a biuret catalyst. Biurets may also be prepared by the reaction of a polyisocyanate with a urea.

Polyisocyanates that may find utility in the production of isocyanurates, iminooxadiazines, biurets, uretdiones and allophanates, and which may find utility in the production of aliphatic and cycloaliphatic isocyanate functional materials for use in the disclosed engineered resin, may include aliphatic and cycloaliphatic diisocyanates, such as, for example, ethylene diisocyanate; 1,4-tetramethylene diisocyanate; 1,6-hexamethylene diisocyanate (“HDI”); 2,2,4-trimethyl-1,6-hexamethylene diisocyanate; 1,12-dodecamethylene diisocyanate; 1-isocyanato-3-isocyanatomethyl-3,5,5-trimethyl-cyclohexane (isophorone diisocyanate or “IPDI”); bis-(4-isocyanatocyclohexyl)methane (“H₁₂MDI”); bis-(4-isocyanato-3-methyl-cyclohexyl)methane, and combinations of any thereof. Additional polyisocyanates (including various diisocyanates) that may also find utility in the production of aliphatic and cycloaliphatic isocyanate functional materials may include the polyisocyanates described in U.S. Pat. Nos. 4,810,820; 5,208,334; 5,124,427; 5,235,018; 5,444,146; and 7,038,003, each of which is incorporated in its entirety by reference herein. Combinations of any of the above-identified and incorporated polyisocyanates may also be used to produce the aliphatic and cycloaliphatic isocyanate functional materials.

In various embodiments, isocyanate functional materials comprising an adduct of a polyisocyanate and a hydroxy-functional compound may find utility in the isocyanate component (A). Isocyanate functional materials may be formed, for example, by reacting an aliphatic or cycloaliphatic polyisocyanate with a hydroxy-functional compound, such as, for example, a mono-functional alcohol (“monoalcohol” or “monol”), a poly-functional alcohol (“polyol”), a mixture of monols, a mixture of polyols, or a mixture of monols and polyols. A polyisocyanate may be reacted with a hydroxy-functional compound to produce a polyisocyanate-hydroxyl compound adduct comprising urethane groups and/or allophanate groups, for example. In certain embodiments, polyisocyanates may be reacted with hydroxy-functional compounds at an OH:NCO molar ratio of 1:1.5 to 1:20. In other embodiments, polyisocyanates may be reacted with hydroxy-functional compounds at an OH:NCO molar ratio of 1:2 to 1:15, or 1:5 to 1:15.

Polyisocyanates that may be used to produce aliphatic and cycloaliphatic isocyanate functional materials may include, for example, the aliphatic and cycloaliphatic diisocyanates described above. Polyisocyanates that may be used to produce isocyanate functional materials may also include, for example, compounds produced from the diisocyanates described above and comprising at least one functional group selected from the group consisting of isocyanurate, iminooxadiazine, uretdione, allophanate, biuret, and combinations of any thereof.

Hydroxy-functional compounds that may be used to produce aliphatic and cycloaliphatic isocyanate functional materials may include, for example, low molecular weight monohydric or polyhydric aliphatic alcohols (which may optionally contain ether groups), monohydric or polyhydric cycloaliphatic alcohols (which may optionally contain ether groups), polythioethers, polyacetals, polycarbonates, polyesters, polyethers, and combinations of any thereof. Hydroxy-functional compounds that may be used to produce aliphatic and cycloaliphatic isocyanate functional materials may also include, for example, the hydroxyl-containing compounds described in U.S. Pat. Nos. 4,810,820; 5,208,334; 5,124,427; 5,235,018; 5,444,146; and 7,038,003, each of which is incorporated in its entirety by reference herein.

In various embodiments, hydroxy-functional polymeric and/or oligomeric polyethers may be used to produce the aliphatic isocyanate functional material. As used herein, the term “polyether” refers to both polymeric and oligomeric compounds containing ether groups. Polyethers that may find utility in producing aliphatic isocyanate functional materials may include polyethers having from one to four free hydroxyl groups. Polyethers may be prepared, for example, by the oligomerization or polymerization of epoxides. Such epoxides may include, for example, ethylene oxide, propylene oxide, butylene oxide, tetrahydrofuran, styrene oxide, or epichlorohydrin. Each epoxide may be reacted alone (e.g., in the presence of boron trifluoride), as a mixture with a starting component having reactive hydrogen atoms, or by successive addition of the epoxide to a starting component having reactive hydrogen atoms. Starting components that may find utility in preparing polyethers may include, for example, water, alcohols, and phenols. Suitable starting components may include ethylene glycol; (1,3)- and (1,2)-propylene glycol; and trimethylolpropane, for example.

In various embodiments, the isocyanate component (A) comprises a) an aliphatic isocyanate functional material comprising a reaction product of a diisocyanate and a hydroxy-functional polyether. Hydroxy-functional polyethers that may find utility in the production of aliphatic isocyanate functional materials may include, for example, hydroxy-functional alkylene ether polyols, such as, for example, hydroxy-functional poly(tetra-methylene glycol), poly(propylene oxide), poly(ethylene oxide), and poly(ethylene-co-propylene oxide). Polyether polyols that may find utility in the production of aliphatic isocyanate functional materials may also include, for example, ethylene oxide and/or propylene oxide adducts of polyols, such as, for example, the ethylene oxide and/or propylene oxide adducts of ethylene glycol or butylene glycol. In certain embodiments, polycaprolactone, which may function similarly to a hydroxy-functional polyether, may find utility in the production of an aliphatic isocyanate functional material.

In various embodiments, hydroxy-functional compounds that may be used to produce b) cycloaliphatic isocyanate functional materials may include, for example, one or more mono-functional alcohols, such as, for example, methanol, ethanol, n-propanol, isopropanol, butanol isomers, pentanol isomers, hexanol isomers, heptanol isomers, octanol isomers, nonanol isomers, decanol isomers, 2-ethylhexanol, trimethyl hexanol, cyclohexanol, fatty alcohols having 11 to 20 carbon atoms, vinyl alcohol, allyl alcohol, and combinations of any thereof. In certain embodiments, mono-functional alcohols that may be used to produce cycloaliphatic isocyanate functional materials may include linear, branched, or cyclic alcohols containing 6 to 9 carbon atoms. In certain embodiments, the mono-functional alcohols may contain ether groups.

In certain embodiments, the a) aliphatic isocyanate functional material may comprise an HDI-based aliphatic isocyanate functional material. The HDI-based aliphatic isocyanate functional material may comprise at least one allophanate group, for example. The HDI-based aliphatic isocyanate functional material may comprise, for example, a reaction product of a hydroxy-functional ether compound and HDI. The ether compound may comprise a hydroxy-functional polyether, for example. A hydroxy-functional polyether may comprise, for example, a polyetherpolyol as described in U.S. Pat. No. 7,038,003, incorporated in its entirety by reference herein.

In various embodiments, a hydroxy-functional polyether may have a number-average molecular weight (Mₙ) of from 300 to 20000 g/mol. In certain embodiments, a hydroxy-functional polyether may have a number-average molecular weight (Mₙ) of from 1000 to 12000 g/mol, and in other embodiments 1000 to 4000 g/mol.

Additionally, hydroxy-functional polyethers may contain less than or equal to 0.02 milliequivalent of unsaturated end groups per gram of polyol (meq/g), in some embodiments less than or equal to 0.015 meq/g, and in other embodiments less than or equal to 0.01 meq/g (determined according to ASTM D 2849-69, incorporated by reference herein). Further, hydroxy-functional polyethers may have a relatively narrow molecular weight distribution (e.g., a polydispersity (M_{w}/Mₙ) of from 1.0 to 1.5) and/or an OH functionality of ≧1.9. In certain embodiments, hydroxy-functional polyethers may have OH functionalities of less than 6, or less than 4, for example.

Hydroxy-functional polyethers that may find utility in the disclosed engineered resins may be prepared by alkoxylating suitable starter molecules, for example, using double metal cyanide catalysts (DMC catalysis), which is described, for example, in U.S. Pat. No. 5,158,922 and E.P. Publication No. A 0 654 302, each of which is incorporated in its entirety by reference herein.

In various embodiments, the HDI-based aliphatic isocyanate functional material may be prepared by reacting HDI with a polyether prepared using DMC catalysis. In certain embodiments, the HDI-based aliphatic isocyanate functional material comprises a reaction product of HDI and polypropylene glycol, characterized in that the reaction product comprises allophanate groups.

The HDI-based aliphatic isocyanate functional material may comprise an average isocyanate functionality of at least 4, a glass transition temperature of less than −40° C., and/or a % NCO of less than 10%. The HDI-based aliphatic isocyanate functional material may be essentially free of HDI isocyanurate trimer.

An HDI-based aliphatic isocyanate functional material comprising a reaction product of a hydroxy-functional compound and HDI, and having at least one allophanate group, may be prepared according to the processes described, for example, in U.S. Pat. No. 7,038,003.

In certain embodiments, the b) cycloaliphatic isocyanate functional material may comprise an IPDI-based cycloaliphatic isocyanate functional material. The IPDI-based cycloaliphatic isocyanate functional material may comprise at least one allophanate group and at least one isocyanurate trimer group, for example. The IPDI-based cycloaliphatic isocyanate functional material may comprise, for example, a reaction product of a mono-functional alcohol and IPDI. The mono-functional alcohol may comprise a monoalcohol as described in U.S. Pat. Nos. 5,124,427; 5,235,018; 5,208,334; and 5,444,146, each of which is incorporated in its entirety by reference herein.

In various embodiments, the IPDI-based cycloaliphatic isocyanate functional material may be prepared by reacting IPDI with a monoalcohol to produce a polyisocyanate mixture having an NCO content of 10% to 47% by weight, a viscosity of less than 10,000 mPa·s, and containing isocyanurate and allophanate groups in a molar ratio of monoisocyanurates to monoallophanates of 10:1 to 1:5. In certain embodiments, the IPDI-based cycloaliphatic isocyanate functional material comprises a reaction product of IPDI and a monoalcohol selected from the group consisting of methanol, ethanol, n-propanol, isopropanol, butanol isomers, pentanol isomers, hexanol isomers, heptanol isomers, octanol isomers, nonanol isomers, decanol isomers, 2-ethylhexanol, trimethyl hexanol, cyclohexanol, fatty alcohols having 11 to 20 carbon atoms, vinyl alcohol, allyl alcohol, and combinations of any thereof. In other embodiments, the monoalcohol may be selected from the group consisting of methanol, ethanol, 1-butanol, 2-butanol, ethylene glycol monomethyl ether, 1-methoxy-2-propanol, isocetyl alcohol, 1-dodecanol, and a mono-hydroxy poly(ethylene oxide), characterized in that the IPDI reaction product comprises isocyanurate and allophanate groups in a molar ratio of monoisocyanurates to monoallophanates of 10:1 to 1:5.

The IPDI-based cycloaliphatic isocyanate functional material may comprise an average isocyanate functionality of at least 2.3, a glass transition temperature between 25° C. and 65° C., and/or a % NCO of 10% to 47% by weight.

In various embodiments, the b) cycloaliphatic isocyanate functional material (e.g., an IPDI-based cycloaliphatic isocyanate functional material) and the a) aliphatic isocyanate functional material (e.g., an HDI-based aliphatic isocyanate functional material) may be combined in a weight ratio ranging from 1:99 to 99:1 cycloaliphatic isocyanate functional material to aliphatic isocyanate functional material. In certain embodiments, the isocyanate component (A) may comprise 95:5 to 50:50 cycloaliphatic isocyanate functional material to aliphatic isocyanate functional material, by weight. In certain other embodiments, the isocyanate component (A) may comprise 75:25 to 65:35 cycloaliphatic isocyanate functional material to aliphatic isocyanate functional material, by weight. In certain other embodiments, the isocyanate component (A) may comprise 73:27 to 69:31 cycloaliphatic isocyanate functional material to aliphatic isocyanate functional material, by weight.

In certain embodiments, the isocyanate component (A) may comprise from 50 weight percent to 100 weight percent b) cycloaliphatic isocyanate functional material (e.g., an IPDI-based cycloaliphatic isocyanate functional material). The isocyanate component (A) may comprise from 0 weight percent to 50 weight percent a) aliphatic isocyanate functional material (e.g., an HDI-based aliphatic isocyanate functional material). In certain other embodiments, the isocyanate component (A) may comprise 50%-99%, 50%-95%, 50%-90%, 50%-80%, 50%-70%, or 50%-60%, by weight, b) cycloaliphatic isocyanate functional material. In certain other embodiments, the isocyanate component (A) may comprise 1%-50%, 5%-50%, 10%-50%, 20%-50%, 30%-50%, or 40%-50%, by weight, a) aliphatic isocyanate functional material.

In certain embodiments, the isocyanate component (A) may comprise 60%-99%, 60%-95%, 60%-90%, 60%-80%, or 60%-70%, by weight, b) cycloaliphatic isocyanate functional material. In certain other embodiments, the isocyanate component (A) may comprise 70%-99%, 70%-95%, 70%-90%, or 70%-80%, by weight, b) cycloaliphatic isocyanate functional material. In certain other embodiments, the isocyanate component (A) may comprise 65%-75%, by weight, b) cycloaliphatic isocyanate functional material.

In certain embodiments, the isocyanate component (A) may comprise 1%-40%, 5%-40%, 10%-40%, 20%-40%, or 30%-40%, by weight, a) aliphatic isocyanate functional material. In certain other embodiments, the isocyanate component (A) may comprise 1%-30%, 5%-30%, 10%-30%, or 20%-30%, by weight, a) aliphatic isocyanate functional material. In certain other embodiments, the isocyanate component (A) may comprise 25%-35%, by weight, a) aliphatic isocyanate functional material.

In certain embodiments, the isocyanate-reactive component (B) may comprise polyaspartic acid esters prepared in accordance with U.S. Pat. Nos. 5,821,326, 5,236,741, 6,169,141, 6,911,501 and 7,276,572, the entire disclosure of each of which are hereby incorporated by reference.

Suitable polyaspartic acid esters for use in accordance with the present invention include those corresponding to the formula:

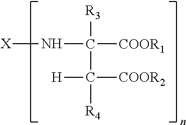

wherein
X represents an organic group which has a valency of n and is inert towards isocyanate groups at a temperature of 100° C. or less, preferably the group obtained, more preferably the hydrocarbon group obtained, by removing the amino groups from an aliphatic, araliphatic or cycloaliphatic polyamine, more preferably a diamine, and
R₁ and R₂ may be the same or different and represent organic groups which are inert towards isocyanate groups at a temperature of 100° C. or less, preferably an alkyl group containing 1 to 9 carbons and more preferably methyl, ethyl or butyl groups, or R₁ and R₂ together with the β-carbon atom form a cycloaliphatic or heterocyclic ring,
R₃ and R₄ may be identical or different and represent hydrogen or organic groups which are inert towards isocyanate groups at a temperature of 100° C. or less and
n has a value of at least 2, preferably 2 to 6, more preferably 2 to 4 and most preferably 2.

These polyaspartic acid esters may be prepared by reacting optionally substituted maleic or fumaric acid esters with polyamines. Suitable optionally substituted maleic or fumaric acid esters are those corresponding to the formula

R₁OOC—CR₃═CR₄—COOR₂

wherein R₁, R₂, R₃ and R₄ are as defined above.

Examples of optionally substituted maleic or fumaric acid esters suitable for use in the preparation of the polyaspartates include dimethyl, diethyl and dibutyl (e.g., di-n-butyl) esters of maleic acid and fumaric acid and the corresponding maleic or fumaric acid esters substituted by methyl in the 2- and/or 3-position.

Suitable polyamines for preparing the polyaspartic acid esters include those corresponding to the formula

X—(—NH₂)ₙ

wherein X and n are as previously defined.

The polyamines include high molecular weight amines having molecular weights of 400 to about 10,000, preferably 400 to about 6,000, and low molecular weight amines having molecular weights below 400. The molecular weights are number average molecular weights (Mₙ) and are determined by end group analysis (NH number). Examples of these polyamines are those wherein the amino groups are attached to aliphatic, cycloaliphatic, araliphatic and/or aromatic carbon atoms.

Suitable low molecular polyamines include ethylene diamine, 1,2- and 1,3-propane diamine, 2-methyl-1,2-propane diamine, 2,2-dimethyl-1,3-propane diamine, 1,3- and 1,4-butane diamine, 1,3- and 1,5-pentane diamine, 2-methyl-1,5-pentane diamine, 1,6-hexane diamine, 2,5-dimethyl-2,5-hexane diamine, 2,2,4- and/or 2,4,4-trimethyl-1,6-hexane diamine, 1,7-heptane diamine, 1,8-octane diamine, 1,9-nonane diamine, triaminononane, 1,10-decane diamine, 1,11-undecane diamine, 1,12-dodecane diamine, 1-amino-3-aminomethyl-3,5,5-trimethyl cyclohexane, 2,4- and/or 2,6-hexahydrotoluoylene diamine, 2,4′- and/or 4,4′-diamino-dicyclohexylmethane, 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 1,3- and/or 1,4-cyclohexane diamine, 1,3-bis(methylamino)-cyclohexane, 1,8-p-menthane diamine, hydrazine, hydrazides of semicarbazido carboxylic acids, bis-hydrazides, bis-semi-carbazides, phenylene diamine, 2,4- and 2,6-toluoylene diamine, 2,3- and 3,4-toluoylene diamine, 2,4′- and/or 4,4′-diaminodiphenyl methane, higher functional polyphenylene polymethylene polyamines obtained by the aniline/formaldehyde condensation reaction, N,N,N-tris-(2-amino-ethyl)-amine, guanidine, melamine, N-(2-aminoethyl)-1,3-propane diamine, 3,3′-diamino-benzidine, polyoxypropylene amines, polyoxy-ethylene amines, 2,4-bis-(4′-aminobenzyl)-aniline and mixtures thereof.

Preferred polyamines are 1-amino-3-aminomethyl-3,5,5-trimethyl-cyclohexane (isophorone diamine or IPDA), bis-(4-aminocyclo-hexyl)-methane, bis-(4-amino-3-methylcyclohexyl)-methane, 1,6-diamino-hexane, 2-methyl pentamethylene diamine, ethylene diamine, triamino-nonane, 2,4- and/or 2,6-toluoylene diamine and 4,4′- and/or 2,4′-diamino-diphenyl methane.

Suitable high molecular weight polyamines include those prepared from the known polyhydroxyl compounds of polyurethane, especially the polyethers. The polyamines may be prepared by reacting the polyhydroxyl compounds with an excess of the previously described polyisocyanates to form NCO prepolymers and subsequently hydrolyzing the terminal isocyanate group to an amino group. Preferably, the polyamines are prepared by converting the terminal hydroxy groups of the polyhydroxyl compounds to amino groups, e.g., by amination. Preferred high molecular weight polyamines are amine-terminated polyethers such as the Jeffamine® resins available from Huntsman International, LLC.

The preparation of the polyaspartic acid esters from the above mentioned starting materials may be carried out, for example, at a temperature of 0 to 100° C. using the starting materials in such proportions that at least 1, preferably 1, olefinic double bond is present for each primary amino group. Excess starting materials may be removed by distillation after the reaction. The reaction may be carried out solvent-free or in the presence of suitable solvents such as methanol, ethanol, propanol, dioxane and mixtures of such solvents.

In certain embodiments, the polyurea coating composition may be prepared by mixing the isocyanate component (A) and the polyaspartic acid ester (B) at an NCO:NH ratio of from about 20:1 to 1:20, in some embodiments from about 10:1 to 1:10, in some embodiments from about 5:1 to 1:5, in some embodiments from about 3:1 to 1:3, in some embodiments from about 2:1 to 1:2, in some embodiments from about 1.5:1 to 1:1.5, in some embodiments from about 1.2:1 to 1:1.2, in some embodiments from about 1.1:1 to 1:1.1 and in some embodiments at 1:1.

In certain embodiments, the polyurea coating composition may comprise the isocyanate component (A), the polyaspartic acid ester (B) and one or more aldimines or ketimines as disclosed in U.S. Pat. Nos. 6,164,141 and 5,623,045, respectively, each of which is incorporated in its entirety herein by reference. Preferably, the polyurea coating composition does not include aldimines or ketimines.

In certain embodiments, the polyurea coating composition may comprise the isocyanate component (A), the polyaspartic acid ester (B) and one or more organic acids, as disclosed in U.S. Pat. No. 5,580,945, which is incorporated in its entirety herein by reference. Preferably, the polyurea coating composition does not include any such organic acids.

In certain embodiments, the polyurea coating composition may comprise the isocyanate component (A), the polyaspartic acid ester (B) and one or more silane adhesion promoters as disclosed in U.S. Pat. Nos. 6,444,325 and 6,887,964, respectively, each of which is incorporated in its entirety herein by reference. Preferably, the polyurea coating composition does not include such silane adhesion promoters.

The polyurea coating composition may comprise the isocyanate component (A), the polyaspartic acid ester (B) and additional components. In various embodiments, the moisture-curable coating composition may comprise, for example, the isocyanate component (A), the polyaspartic acid ester (B), additive resins, pigments, tint pastes, pigment wetting agents, pigment dispersants, light stabilizers, UV-absorbers, rheology modifiers, defoamers, dehydrators, solvents, catalysts, or additives to affect, for example, substrate wetting, film leveling, coating surface tension, pigment grinding, pigment deflocculation, or gloss.

In certain embodiments, the polyurea coating composition may comprise the isocyanate component (A), the polyaspartic acid ester (B) and one or more additive resins, such as, for example, Joncryl® 611 (BASF Corporation) and/or Neocryl B-734™ (DSM N.V.). Joncryl® 611 is a styrene-acrylic acid copolymer resin. Joncryl® 611 may be used as an additive resin in a polyurea coating composition to affect pigment dispersion and film-forming properties, for example. Neocryl B734™ is a methyl methacrylate, n-butyl methacrylate copolymer resin. Neocryl B-734™ may be used as an additive resin to affect pigment dispersion and film-forming properties, for example.

In certain embodiments, the polyurea coating composition may comprise the isocyanate component (A), the polyaspartic acid ester (B) and one or more pigments, such as, for example, titanium dioxide. Pigments that may find utility in the disclosed polyurea coating composition may include, for example, Kronos™ 2310 (Kronos Worldwide, Inc.) and/or TiPure® R-706 (DuPont). In certain embodiments, the disclosed polyurea coating composition may comprise one or more fillers. Fillers that may find utility in the disclosed polyurea coating composition may include, for example, Imsil® A-10 (Unimin Corporation) and/or Nytal® 3300 (R. T. Vanderbilt Company).

In certain embodiments, the polyurea coating composition may comprise the isocyanate component (A), the polyaspartic acid ester (B) and one or more pigment wetting agents or dispersants. Pigment wetting agents and dispersants that may find utility in the disclosed polyurea coating composition may include, for example, Disperbyk®-110 (BYK-Chemie GmbH), Disperbyke-192 (BYK-Chemie GmbH), and/or Anti-Terra U (BYK-Chemie GmbH).

The polyurea coating composition may comprise the isocyanate component (A), the polyaspartic acid ester (B) and one or more rheology modifiers. Rheology modifiers that may find utility in the disclosed polyurea coating composition may include, for example, Byk® 430, Byk® 431 (BYK-Chemie GmbH), Bentonite clays, and/or castor oil derivatives. In certain embodiments, a polyurea coating composition may comprise the disclosed engineered resin and one or more defoamers. Defoamers that may find utility in the disclosed polyurea coating composition may include, for example, Byk® 077 (BYK-Chemie GmbH).

In certain embodiments, the polyurea coating composition may comprise the isocyanate component (A), the polyaspartic acid ester (B) and one or more light stabilizers and/or UV-absorbers. Light stabilizers that may find utility in the disclosed polyurea coating composition may include, for example, Tinuvin® 292 (Ciba/BASF). UV-absorbers that may find utility in the disclosed polyurea coating composition may include, for example, Tinuvin® 1130 (Ciba/BASF). In certain other embodiments, the polyurea coating composition may comprise the isocyanate component (A), the polyaspartic acid ester (B) and one or more dehydrators. Dehydrators that may find utility in the polyurea coating composition may include, for example, p-toluenesulfonyl isocyanate, isophorone diisocyanate, and/or hexamethylene diisocyanate.

In other embodiments, the polyurea coating composition may comprise the isocyanate component (A), the polyaspartic acid ester (B) and one or more catalysts, such as, for example, dibutyltin dilaurate or a tertiary amine. Catalysts that may find utility in the disclosed polyurea coating composition may include, for example, Dabco® T-12 (Air Products and Chemicals, Inc.) and/or 1,4-diazabicyclo[2.2.2]octane.

The polyurea coating composition may comprise the isocyanate component (A), the polyaspartic acid ester (B) and one or more additional additives. Additional additives that may find utility in the disclosed polyurea coating composition may include, for example, Byk® 358, and/or Byk® 306 (BYK-Chemie GmbH).

In certain embodiments, the polyurea coating composition may comprise the isocyanate component (A), the polyaspartic acid ester (B) and one or more solvents. Solvents that may find utility in the disclosed polyurea coating composition may include, for example, methyl n-amyl ketone (“MAK”), Aromatic™ 100 (ExxonMobile Chemical), Aromatic™ 150 (ExxonMobile Chemical), xylene, methyl isobutyl ketone (“MIBK”), ethyl 3-ethoxypropionate (Eastman™ EEP solvent, Eastman Chemical Company), and/or methyl ethyl ketone (“MEK”).

The application of the polyurea coating composition of the present invention to the substrate to be coated takes place with the methods known and customary in coatings technology, such as spraying, knife coating, curtain coating, vacuum coating, rolling, pouring, dipping, spin coating, squeegeeing, brushing or squirting or by means of printing techniques such as screen, gravure, flexographic or offset printing and also by means of transfer methods.

The polyurea coating composition of the present invention finds particular utility in the coating of metal substrates. In particular, the polyurea coating composition shows improved adhesion over known coating compositions with respect to new or weathered galvanized steel, treated or untreated steel, treated or untreated aluminum and metal alloys.

Suitable substrates also include, for example, wood, plastic, including plastic in the form of films, especially ABS, AMMA, ASA, CA, CAB, EP, UF, CF, MF, MPF, PF, PAN, PA, PE, HDPE, LDPE, LLDPE, UHMWPE, PET, PMMA, PP, PS, SB, FUR, PVC, RF, SAN, PBT, PPE, POM, PUR-RIM, SMC, BMC, PP-EPDM, and UP (abbreviations according to DIN 7728T1), paper, leather, textiles, felt, glass, wood, wood materials, cork, inorganically bonded substrates such as wooden boards and fiber cement slabs, electronic assemblies or mineral substrates. It is also possible to coat substrates consisting of a variety of the above-mentioned materials, or to coat already coated substrates such as vehicles, aircraft or boats and also parts thereof, especially vehicle bodies or parts for exterior mounting. It is also possible to apply the coating compositions to a substrate temporarily, then to cure them partly or fully and optionally to detach them again, in order to produce films, for example.

The illustrative and non-limiting examples that follow are intended to further describe the embodiments presented herein without restricting their scope. Persons having ordinary skill in the art will appreciate that variations of the Examples are possible within the scope of the invention as defined solely by the claims. All parts and percents are by weight unless otherwise indicated.

### EXAMPLES

### Materials Used in the Examples

Desmophen® NH 1420—polyaspartic acid ester prepared from bis-(4-aminocyclohexyl)-methane (amine number of 195-205) available from Bayer MaterialScience LLC.

Desmodur® N-75 BA—Aliphatic polyisocyanate based on hexamethylene diisocyanate (HDI) and dissolved in n-butyl acetate and xylene (1:1), having an NCO content of 16.5 wt. %, available from Bayer MaterialScience LLC.

Desmodur® XP 2714—Silane-functional aliphatic polyisocyanate based on hexamethylene diisocyanate, having an NCO content of 15.9 wt. %, available from Bayer MaterialScience LLC.

### Example 1

An isocyanate-functional material was prepared according to one embodiment. The isocyanate functional material comprised 30 weight percent of an HDI-based aliphatic isocyanate functional material (the “HDI-based material”) and 70 weight percent of an IPDI-based cycloaliphatic isocyanate functional material (the “IPDI-based material”)).

The HDI-based material comprised an allophanate reaction product of HDI and a hydroxy-functional polyether prepared using DMC catalysis. The HDI was reacted with the polyether using the processes described in U.S. Pat. No. 7,038,018. The HDI-based material had an average isocyanate functionality of greater than or equal to 4, a glass transition temperature of less than −40° C., and a % NCO of less than 10% by weight. The HDI-based material was essentially free of HDI isocyanurate trimer.

The IPDI-based material comprised an allophanate-modified isocyanurate trimer reaction product of IPDI and a monol. The IPDI was reacted with the monol using the processes described in U.S. Pat. Nos. 5,124,427 and 5,235,018. The IPDI-based material had an average isocyanate functionality of at least 2.3, a glass transition temperature between 25° C. and 65° C., and a % NCO of 10% to 20% by weight.

### Procedure for Examples 2-9

Coating compositions were made according to the procedure of Example 2, with the specific formulations listed in each respective Example.

Desmophen NH-1420, Byk 307 and Kronos 2310 are charged into the high speed grinding vessel and milled to a Hegman 6.5. Tinuvins 292 and 1130 along with DBE-9 are added in the letdown. The coating composition was mixed for an additional 10 minutes. When applied the polyol portion is mixed with the polyisocyanate portion completely and applied.

B952 (zinc phosphatized pre-treated steel), B1000 (iron phosphatized pre-treated steel), Cold Roll Steel, Mill Finish Aluminum, and Chromate Treated Aluminum panels were sprayed with the coating composition of each respective Example at a DFT of 1.5-2 mils, The panels were cured in a constant temperature room (72° F./50% RH) and at 77° F./78% RH in a Thermatron. After curing, 1 set of panels from each curing condition were put in a humidity cabinet (“CC”) for 4 days. A crosshatch adhesion test was performed according to the ASTM methods D3359-02 Method B.

### Example 2

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 76.80 | 8.73 | 76.80 | 8.73 |
| Byk-307 (10% Cut in Solvent) | 3.40 | 0.46 | 0.34 | 0.04 |
| Kronos 2310 | 110.39 | 3.31 | 110.39 | 3.31 |
| Grind to a 6.5 Hegman. | | | | |
| Tinuvin 292 | 1.36 | 0.16 | 1.36 | 0.16 |
| Tinuvin 1130 | 2.72 | 0.28 | 2.72 | 0.28 |
| DBE-9 | 71.34 | 7.80 | 0 | 0 |
| SubTotal I | 266.01 | 20.74 | 191.61 | 12.52 |

Component II

| | | | | |
|---|---|---|---|---|
| Isocyanate-functional | 124.63 | 14.13 | 107.18 | 11.77 |
| Material from Example 1 | | | | |
| Amyl Acetate | 9.36 | 1.28 | 0 | 0 |
| SubTotal II | 133.99 | 15.41 | 107.18 | 11.77 |
| Total | 400.00 | 36.15 | 298.79 | 24.29 |

### Theoretical Results

| | |
|---|---|
| Weight Solids | 74.70 |
| Volume Solids | 67.19 |
| P/B | 0.60 |
| PVC | 13.91 |
| Wt/Gal | 11.07 |
| Mix Ratio (volume) | 1.35:1 |
| NCO:NH | 1.10 |
| Theoretical VOC | 2.80 |

### Dry Time:

| | 4.63 g/w |
|---|---|
| Set to Touch | 25 min. |
| Tack Free | 50 min. |
| Hard Dry | 70 min. |

### Dry Adhesion:

| | | | 4.63 g/w | 10.77 g/w |
|---|---|---|---|---|
| | | DFT | x-hatch | x-hatch |
| B952 | 1 day cut | | 5B | 3B |
| | 7 day cut | | 5B | 1B |
| | 14 day cut | | 5B | 0B |
| | 28 day cut | | 5B | 1B |
| B1000 | 1 day cut | | 5B | 5B |
| | 7 day cut | | 5B | 5B |
| | 14 day cut | | 5B | 4B |
| | 28 day cut | | 5B | 4B |
| Cold Roll Steel | 1 day cut | | 0B | 0B |
| | 7 day cut | | 0B | 0B |
| | 14 day cut | | 0B | 0B |
| | 28 day cut | | 0B | 0B |
| Alum. Untreated | 1 day cut | | 0B | 0B |
| | 7 day cut | | 0B | 0B |
| | 14 day cut | | 0B | 0B |
| | 28 day cut | | 0B | 0B |
| Alum. Treated | 1 day cut | | 0B | 0B |
| | 7 day cut | | 0B | 0B |
| | 14 day cut | | 0B | 0B |
| | 28 day cut | | 0B | 0B |
| B1000 No Parcloene | 1 day cut | | 5B | 5B |
| | 7 day cut | | 5B | 4B |
| | 14 day cut | | 3B | 2B |
| | 28 day cut | | 5B | 5B |

### Wet Adhesion:

| | | 4.63 g/w | 10.77 g/w |
|---|---|---|---|
| | | x-hatch | x-hatch |
| B952 | 4 days in CC | NA | 0B |
| B1000 | 4 days in CC | 4B | 5B |
| Cold Roll Steel | 4 days in CC | 0B | 0B |
| Alum. Untreated | 4 days in CC | 0B | 0B |
| Alum. Treated | 4 days in CC | 0B | 0B |
| B1000 No Parcloene | 4 days in CC | 0B | 0B |

### Example 3

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 72.94 | 8.29 | 72.94 | 8.29 |
| Byk-307 (10% Cut in Solvent) | 3.40 | 0.46 | 0.34 | 0.04 |
| Kronos 2310 | 110.39 | 3.31 | 110.39 | 3.31 |
| Grind to a 6.5 Hegman. | | | | |
| Tinuvin 292 | 1.38 | 0.16 | 1.36 | 0.16 |
| Tinuvin 1130 | 2.72 | 0.28 | 2.72 | 0.28 |
| DBE-9 | 70.78 | 7.74 | 0 | 0 |
| SubTotal I | 261.59 | 20.24 | 187.74 | 12.08 |

Component II

| | | | | |
|---|---|---|---|---|
| Isocyanate-functional | 129.12 | 14.64 | 111.05 | 12.19 |
| Material from Example 1 | | | | |
| Amyl Acetate | 9.29 | 1.27 | 0 | 0 |
| SubTotal II | 138.41 | 15.91 | 111.05 | 12.19 |
| Total | 400.00 | 36.15 | 298.79 | 24.27 |

### Theoretical Results

| | |
|---|---|
| Weight Solids | 74.70 |
| Volume Solids | 67.15 |
| P/B | 0.60 |
| PVC | 13.92 |
| Wt/Gal | 11.07 |
| Mix Ratio (volume) | 1.27:1 |
| NCO:NH | 1.20 |
| Theoretical VOC | 2.80 |

### Dry Time:

| | 4.63 g/w |
|---|---|
| Set to Touch | 50 min. |
| Tack Free | 85 min. |
| Hard Dry | 145 min. |

### Dry Adhesion:

| | | | 4.63 g/w | 10.77 g/w |
|---|---|---|---|---|
| | | DFT | x-hatch | x-hatch |
| B952 | 1 day cut | | 5B | 5B |
| | 7 day cut | | 5B | 2B |
| | 14 day cut | | 5B | 2B |
| | 28 day cut | | 5B | 2B |
| B1000 | 1 day cut | | 5B | 5B |
| | 7 day cut | | 5B | 5B |
| | 14 day cut | | 5B | 3B |
| | 28 day cut | | 5B | 5B |
| Cold Roll Steel | 1 day cut | | 0B | 0B |
| | 7 day cut | | 0B | 0B |
| | 14 day cut | | 0B | 0B |
| | 28 day cut | | 0B | 0B |
| Alum. Untreated | 1 day cut | | 0B | 0B |
| | 7 day cut | | 0B | 0B |
| | 14 day cut | | 0B | 0B |
| | 28 day cut | | 0B | 0B |
| Alum. Treated | 1 day cut | | 0B | 0B |
| | 7 day cut | | 0B | 0B |
| | 14 day cut | | 0B | 0B |
| | 28 day cut | | 0B | 0B |
| B1000 No Parcloene | 1 day cut | | 5B | 5B |
| | 7 day cut | | 5B | 3B |
| | 14 day cut | | 5B | 2B |
| | 28 day cut | | 5B | 4B |

### Wet Adhesion:

| | | 4.63 g/w | 10.77 g/w |
|---|---|---|---|
| | | x-hatch | x-hatch |
| B952 | 4 days in CC | 0B | 0B |
| B1000 | 4 days in CC | 5B | 4B |
| Cold Roll Steel | 4 days in CC | 0B | 0B |
| Alum. Untreated | 4 days in CC | 0B | 0B |
| Alum. Treated | 4 days in CC | 0B | 0B |
| B1000 No Parcloene | 4 days in CC | 0B | 0B |

### Example 4

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 173.94 | 19.77 | 173.94 | 19.77 |
| Byk-307 (10% Cut in Solvent) | 9.63 | 1.30 | 0.96 | 0.11 |
| Kronos 2310 | 315.31 | 9.46 | 315.31 | 9.46 |
| Grind to a 6.5 Hegman. | | | | |
| Tinuvin 292 | 3.85 | 0.47 | 3.85 | 0.47 |
| Tinuvin 1130 | 7.71 | 0.79 | 7.71 | 0.79 |
| DBE-9 | 227.21 | 24.83 | 0 | 0 |
| SubTotal I | 737.65 | 56.61 | 501.77 | 30.59 |

Component II

| | | | | |
|---|---|---|---|---|
| Desmodur XP 2714 | 263.68 | 27.73 | 263.68 | 27.73 |
| Isocyanate-functional | 102.20 | 11.59 | 87.89 | 9.65 |
| Material from Example 1 | | | | |
| Amyl Acetate | 29.81 | 4.08 | 0 | 0 |
| SubTotal II | 395.70 | 43.39 | 351.58 | 37.37 |
| Total | 1133.35 | 100.00 | 853.35 | 67.96 |

### Theoretical Results

| | |
|---|---|
| Weight Solids | 75.29 |
| Volume Solids | 67.96 |
| P/B | 0.60 |
| PVC | 14.20 |
| Wt/Gal | 11.33 |
| Mix Ratio (volume) | 1.30:1 |
| NCO:NH | 2.00 |
| Theoretical VOC | 2.80 |

### Dry Time:

| | 4.63 g/w |
|---|---|
| Set to Touch | 45 min. |
| Tack Free | 75 min. |
| Hard Dry | 125 min. |

### Dry Adhesion:

| | | | 4.63 g/w | 10.77 g/w |
|---|---|---|---|---|
| | | DFT | x-hatch | x-hatch |
| B952 | 1 day cut | | 5B | 5B |
| | 7 day cut | | 5B | 5B |
| | 14 day cut | | 5B | 5B |
| | 28 day cut | | 5B | 5B |
| B1000 | 1 day cut | | 5B | 5B |
| | 7 day cut | | 5B | 5B |
| | 14 day cut | | 5B | 5B |
| | 28 day cut | | 5B | 5B |
| Cold Roll Steel | 1 day cut | | 5B | 5B |
| | 7 day cut | | 3B | 0B |
| | 14 day cut | | 4B | 0B |
| | 28 day cut | | 2B | 0B |
| Alum. Untreated | 1 day cut | | 5B | 5B |
| | 7 day cut | | 5B | 3B |
| | 14 day cut | | 3B | 2B |
| | 28 day cut | | 3B | 0B |
| Alum. Treated | 1 day cut | | 3B | 5B |
| | 7 day cut | | 3B | 0B |
| | 14 day cut | | 3B | 0B |
| | 28 day cut | | 2B | 0B |

### Wet Adhesion:

| | | 4.63 g/w | 10.77 g/w |
|---|---|---|---|
| | | x-hatch | x-hatch |
| B952 | 4 days in CC | 2B | 2B |
| B1000 | 4 days in CC | 3B | 1B |
| Cold Roll Steel | 4 days in CC | 0B | 0B |
| Alum. Untreated | 4 days in CC | 5B | 5B |
| Alum. Treated | 4 days in CC | 0B | 5B |

### Example 5

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 145.32 | 16.51 | 145.32 | 16.51 |
| Byk-307 (10% Cut in Solvent) | 9.48 | 1.28 | 0.95 | 0.11 |
| Kronos 2310 | 308.45 | 9.25 | 308.45 | 9.25 |
| Grind to a 6.5 Hegman. | | | | |
| Tinuvin 292 | 3.79 | 0.46 | 3.79 | 0.46 |
| Tinuvin 1130 | 7.58 | 0.78 | 7.58 | 0.78 |
| DBE-9 | 211.44 | 23.11 | 0 | 0 |
| SubTotal I | 686.06 | 51.38 | 466.09 | 27.11 |

Component II

| | | | | |
|---|---|---|---|---|
| Isocyanate-functional | 428.79 | 48.62 | 368.76 | 40.48 |
| Material from Example 1 | | | | |
| SubTotal II | 428.79 | 48.62 | 368.76 | 40.48 |
| Total | 1114.85 | 100.00 | 834.85 | 67.59 |

### Theoretical Results

| | |
|---|---|
| Weight Solids | 74.88 |
| Volume Solids | 67.59 |
| P/B | 0.60 |
| PVC | 13.97 |
| Wt/Gal | 11.15 |
| Mix Ratio (volume) | 1.06:1 |
| NCO:NH | 2.00 |
| Theoretical VOC | 2.80 |

### Dry Time:

| | 4.63 g/w |
|---|---|
| Set to Touch | 25 min. |
| Tack Free | 60 min. |
| Hard Dry | 120 min. |

### Dry Adhesion:

| | | | 4.63 g/w | 10.77 g/w | 13.26 g/w |
|---|---|---|---|---|---|
| | | DFT | x-hatch | x-hatch | x-hatch |
| B952 | | 1.6 | | | |
| | 1 day cut | | 5B | 5B | 5B |
| | 7 day cut | | 5B | 4B | 3B |
| | 14 day cut | | 5B | 3B | 0B |
| | 28 day cut | | 5B | 1B | 0B |
| B1000 | | 1.4 | | | |
| | 1 day cut | | 5B | 5B | 4B |
| | 7 day cut | | 5B | 5B | 2B |
| | 14 day cut | | 5B | 4B | 0B |
| | 28 day cut | | 5B | 2B | 2B |
| Cold Roll Steel | | 1.55 | | | |
| | 1 day cut | | 5B | 0B | 0B |
| | 7 day cut | | 4B | 0B | 0B |
| | 14 day cut | | 3B | 0B | 0B |
| | 28 day cut | | 4B | 0B | 0B |
| Alum. Untreated | | 1.6 | | | |
| | 1 day cut | | 5B | 0B | 0B |
| | 7 day cut | | 4B | 0B | 0B |
| | 14 day cut | | 3B | 0B | 0B |
| | 28 day cut | | 3B | 0B | 0B |
| Alum. Treated | | 1.2 | | | |
| | 1 day cut | | 5B | 2B | 2B |
| | 7 day cut | | 5B | 0B | 0B |
| | 14 day cut | | 5B | 0B | 0B |
| | 28 day cut | | 4B | 0B | 0B |

### Wet Adhesion:

| | | 4.63 g/w | 10.77 g/w | 13.26 g/w |
|---|---|---|---|---|
| | | x-hatch | x-hatch | x-hatch |
| B952 | 4 days in CC | 4B | 0B | 0B |
| B1000 | 4 days in CC | 4B | 4B | 0B |
| Cold Roll Steel | 4 days in CC | 0B | 0B | 0B |
| Alum. Untreated | 4 days in CC | 0B | 0B | 0B |
| Alum. Treated | 4 days in CC | 0B | 0B | 0B |

### Example 6

A commercially available system utilizing Desmophen NH 1420 and Desmodur N-75 BA/X indexed at an NCO:NH ratio of 1:1 was tested in accordance with Examples 2-5 above.

### Theoretical Results

| | |
|---|---|
| Weight Solids | 63.82 |
| Volume Solids | 52.82 |
| P/B | 0.42 |
| PVC | 10.24 |
| Wt/Gal | 9.53 |
| Mix Ratio (volume) | 0.78:1 |
| NCO:NH | 1.10 |
| Theoretical VOC | 3.45 |

### Dry Time:

| | 4.63 g/w |
|---|---|
| Set to Touch | 5 min. |
| Tack Free | 10 min. |
| Hard Dry | 20 min. |

### Dry Adhesion:

| | | | 4.63 g/w | 10.77 g/w | 13.26 g/w |
|---|---|---|---|---|---|
| | | DFT | x-hatch | x-hatch | x-hatch |
| B952 | | 2.25 | | | |
| | 1 day cut | | 5B | 5B | 4B |
| | 7 day cut | | 4B | 2B | 1B |
| | 14 day cut | | 4B | 0B | 0B |
| | 28 day cut | | 3B | 0B | 0B |
| B1000 | | 2.35 | | | |
| | 1 day cut | | 5B | 4B | 4B |
| | 7 day cut | | 5B | 4B | 4B |
| | 14 day cut | | 4B | 4B | 4B |
| | 28 day cut | | 5B | 2B | 3B |
| Cold Roll Steel | | 2.35 | | | |
| | 1 day cut | | 0B | 0B | 0B |
| | 7 day cut | | 0B | 0B | 0B* |
| | 14 day cut | | 0B | 0B | NA |
| | 28 day cut | | 0B | 0B | NA |
| Alum. Untreated | | 1.73 | | | |
| | 1 day cut | | 0B | 0B | 0B |
| | 7 day cut | | 0B | 0B | 0B |
| | 14 day cut | | 0B | 0B | 0B |
| | 28 day cut | | 0B | 0B | 0B |
| Alum. Treated | | 1.7 | | | |
| | 1 day cut | | 0B | 0B | 0B |
| | 7 day cut | | 0B | 0B | 0B |
| | 14 day cut | | 0B | 0B | 0B |
| | 28 day cut | | 0B | 0B | 0B |

*The coating peeled from the substrate.

### Wet Adhesion:

| | | 4.63 g/w | 10.77 g/w | 13.26 g/w |
|---|---|---|---|---|
| | | x-hatch | x-hatch | x-hatch |
| B952 | 4 days in CC | 0B | 0B | NA |
| B1000 | 4 days in CC | 0B | 1B | NA |
| Cold Roll Steel | 4 days in CC | 0B | 0B | NA |
| Alum. Untreated | 4 days in CC | 0B | 0B | NA |
| Alum. Treated | 4 days in CC | 0B | 0B | NA |

### Example 7

A commercially available system utilizing Desmophen NH 1420 and Desmodur N-75 BA/X indexed at an NCO:NH ratio of 1:7 was tested in accordance with Examples 2-5 above.

### Theoretical Results

| | |
|---|---|
| Weight Solids | 64.00 |
| Volume Solids | 52.82 |
| P/B | 0.42 |
| PVC | 10.32 |
| Wt/Gal | 9.57 |
| Mix Ratio (volume) | 0.62:1 |
| NCO:NH | 1.70 |
| Theoretical VOC | 3.45 |

### Dry Time:

| | 4.63 g/w |
|---|---|
| Set to Touch | 10 min. |
| Tack Free | 15 min. |
| Hard Dry | 25 min. |

### Dry Adhesion:

| | | | 4.63 g/w | 10.77 g/w |
|---|---|---|---|---|
| | | DFT | x-hatch | x-hatch |
| B952 | | 2.57 | | |
| | 1 day cut | | 5B | 5B |
| | 7 day cut | | 5B | 5B |
| | 14 day cut | | 5B | 5B |
| | 28 day cut | | 5B | 5B |
| B1000 | | 2.4 | | |
| | 1 day cut | | 5B | 5B |
| | 7 day cut | | 5B | 5B |
| | 14 day cut | | 5B | 5B |
| | 28 day cut | | 5B | 5B |
| Cold Roll Steel | | 2.55 | | |
| | 1 day cut | | 1B | 0B |
| | 7 day cut | | 0B | 0B |
| | 14 day cut | | 0B | 0B |
| | 28 day cut | | 0B | 0B |
| Alum. Untreated | | 2.23 | | |
| | 1 day cut | | 5B | 0B |
| | 7 day cut | | 0B | 0B |
| | 14 day cut | | 0B | 0B |
| | 28 day cut | | 0B | 0B |
| Alum. Treated | | 2.15 | | |
| | 1 day cut | | 3B | 0B |
| | 7 day cut | | 0B | 0B |
| | 14 day cut | | 0B | 0B |
| | 28 day cut | | 0B | 0B |

### Wet Adhesion:

| | | 4.63 g/w | 10.77 g/w |
|---|---|---|---|
| | | x-hatch | x-hatch |
| B952 | 4 days in CC | 5B | 1B |
| B1000 | 4 days in CC | 0B | 4B |
| Cold Roll Steel | 4 days in CC | 0B | 0B |
| Alum. Untreated | 4 days in CC | 1B | 0B |
| Alum. Treated | 4 days in CC | 0B | 0B |

### Example 8

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 257.57 | 29.27 | 257.57 | 29.27 |
| Byk-307 (10% Cut in Solvent) | 9.64 | 1.30 | 0.96 | 0.11 |
| Kronos 2310 | 315.44 | 9.46 | 315.44 | 9.46 |
| Grind to a 6.5 Hegman. | | | | |
| Tinuvin 292 | 3.85 | 0.47 | 3.85 | 0.47 |
| Tinuvin 1130 | 7.71 | 0.79 | 7.71 | 0.79 |
| DBE-9 | 239.85 | 26.21 | 0 | 0 |
| SubTotal I | 834.06 | 67.50 | 585.54 | 40.10 |

Component II

| | | | | |
|---|---|---|---|---|
| Desmodur XP 2714 | 268.15 | 28.20 | 268.15 | 28.20 |
| Amyl Acetate | 31.47 | 4.31 | 0 | 0 |
| SubTotal II | 299.63 | 32.50 | 268.15 | 28.20 |
| Total | 1133.69 | 100.00 | 853.69 | 68.29 |

### Theoretical Results

| | |
|---|---|
| Weight Solids | 75.30 |
| Volume Solids | 68.29 |
| P/B | 0.60 |
| PVC | 14.14 |
| Wt/Gal | 11.34 |
| Mix Ratio (volume) | 2.08:1 |
| NCO:NH | 1.10 |
| Theoretical VOC | 2.80 |

### Dry Time:

| | 4.63 g/w |
|---|---|
| Set to Touch | 15 min. |
| Tack Free | 40 min. |
| Hard Dry | 50 min. |

### Dry Adhesion:

| | | | 4.63 g/w | 10.77 g/w |
|---|---|---|---|---|
| | | DFT | x-hatch | x-hatch |
| B952 | | 1.59 | | |
| | 1 day cut | | 5B | 5B |
| | 7 day cut | | 5B | 5B |
| | 14 day cut | | 5B | 3B |
| | 28 day cut | | 5B | 2B |
| B1000 | | 1.61 | | |
| | 1 day cut | | 5B | 5B |
| | 7 day cut | | 5B | 5B |
| | 14 day cut | | 5B | 5B |
| | 28 day cut | | 5B | 1B |
| Cold Roll Steel | | 1.81 | | |
| | 1 day cut | | 3B | 2B |
| | 7 day cut | | 0B | 5B |
| | 14 day cut | | 0B | 3B |
| | 28 day cut | | 0B | 0B |
| Alum. Untreated | | 1.83 | | |
| | 1 day cut | | 5B | 1B |
| | 7 day cut | | 5B | 5B |
| | 14 day cut | | 5B | 5B |
| | 28 day cut | | 4B | 5B |
| Alum. Treated | | 1.97 | | |
| | 1 day cut | | 5B | 0B |
| | 7 day cut | | 5B | 0B |
| | 14 day cut | | 5B | 0B |
| | 28 day cut | | 5B | 0B |

### Wet Adhesion:

| | | 4.63 g/w | 10.77 g/w |
|---|---|---|---|
| | | x-hatch | x-hatch |
| B952 | 4 days in CC | 5B | 0B |
| B1000 | 4 days in CC | 4B | 0B |
| Cold Roll Steel | 4 days in CC | 0B | 0B |
| Alum. Untreated | 4 days in CC | 5B | 1B |
| Alum. Treated | 4 days in CC | 5B | 0B |

### Salt Fog:

| | | | | | | | | | |
|---|---|---|---|---|---|---|---|---|---|
| Panel 1 | 114 Hrs. | 200 Hrs | 300 Hrs | 500 Hrs | Panel 2 | 114 Hrs. | 200 Hrs | 300 Hrs | 500 Hrs |

(B952)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the scribe | 6D | 6D | 4D | 2D | 6D | 6D | 4D | 2D |
| Rusting on the scribe | 8 | 3 | 3 | 0 | 8 | 3 | 3 | 0 |
| Unscribed: | | | | | | | | |
| Rusting in the field | 10 | 10 | 10 | 10 | 10 | 10 | 10 | 10 |
| Blistering in the field | None | None | None | None | None | None | None | None |

(B1000)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the scribe | None | 4F | 4D | 2D | None | None | 4D | 2D |
| Rusting on the scribe | 10 | 10 | 3 | 0 | 10 | 10 | 3 | 0 |
| Unscribed: | | | | | | | | |
| Rusting in the field | 10 | 10 | 10 | 10 | 10 | 10 | 10 | 10 |
| Blistering in the field | None | None | None | None | None | None | None | None |

(CRS)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the scribe | None | 2M | 4D | 2D | None | None | 4D | 2D |
| Rusting on the scribe | 8 | 5 | 3 | 0 | 8 | 8 | 3 | 0 |
| Unscribed: | | | | | | | | |
| Rusting in the field | 10 | 10 | 10 | 10 | 10 | 10 | 10 | 10 |
| Blistering in the field | None | None | None | None | None | None | None | None |

(Mill Finish)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the scribe | None | None | None | None | None | None | None | None |
| Rusting on the scribe | 10 | 10 | 10 | 10 | 10 | 10 | 10 | 10 |
| Unscribed: | | | | | | | | |
| Rusting in the field | 10 | 10 | 10 | 10 | 10 | 10 | 10 | 10 |
| Blistering in the field | None | None | None | None | None | None | None | None |

(Chromate Finish)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the scribe | None | None | None | None | None | None | None | None |
| Rusting on the scribe | 10 | 10 | 10 | 10 | 10 | 10 | 10 | 10 |
| Unscribed: | | | | | | | | |
| Rusting in the field | 10 | 10 | 10 | 10 | 10 | 10 | 10 | 10 |
| Blistering in the field | None | None | None | None | None | None | None | None |

### Example 9

| | | | | |
|---|---|---|---|---|
| | | | Weight | Volume |
| Raw Material | Weight | Volume | Solids | Solids |

Component I

| | | | | |
|---|---|---|---|---|
| Desmophen NH 1420 | 183.46 | 20.85 | 183.46 | 20.85 |
| Byk-307 (10% Cut in Solvent) | 9.71 | 1.31 | 0.97 | 0.11 |
| Kronos 2310 | 318.44 | 9.55 | 318.44 | 9.55 |
| Grind to a 6.5 Hegman. | | | | |
| Tinuvin 292 | 3.88 | 0.47 | 3.88 | 0.47 |
| Tinuvin 1130 | 7.76 | 0.79 | 7.76 | 0.79 |
| DBE-9 | 239.80 | 26.21 | 0 | 0 |
| SubTotal I | 763.06 | 59.18 | 514.53 | 31.78 |

Component II

| | | | | |
|---|---|---|---|---|
| Desmodur XP 2714 | 347.27 | 36.52 | 347.27 | 36.52 |
| Amyl Acetate | 31.47 | 4.30 | 0 | 0 |
| SubTotal II | 378.74 | 40.82 | 347.27 | 36.52 |
| Total | 1141.80 | 100.00 | 861.80 | 68.29 |

### Theoretical Results

| | |
|---|---|
| Weight Solids | 75.48 |
| Volume Solids | 68.29 |
| P/B | 0.60 |
| PVC | 14.27 |
| Wt/Gal | 11.42 |
| Mix Ratio (volume) | 1.45:1 |
| NCO:NH | 2.00 |
| Theoretical VOC | 2.80 |

### Dry Time:

| | 4.63 g/w |
|---|---|
| Set to Touch | 150 min. |
| Tack Free | 225 min. |
| Hard Dry | >360 min. |

### Dry Adhesion:

| | | | 4.63 g/w | 10.77 g/w |
|---|---|---|---|---|
| | | DFT | x-hatch | x-hatch |
| B952 | | 1.68 | | |
| | 1 day cut | | 5B | 5B |
| | 7 day cut | | 5B | 5B |
| | 14 day cut | | 5B | 5B |
| | 28 day cut | | 5B | 5B |
| B1000 | | 1.6 | | |
| | 1 day cut | | 5B | 5B |
| | 7 day cut | | 5B | 5B |
| | 14 day cut | | 5B | 5B |
| | 28 day cut | | 5B | 4B |
| Cold Roll Steel | | 1.65 | | |
| | 1 day cut | | 5B | 2B |
| | 7 day cut | | 0B | 5B |
| | 14 day cut | | 0B | 5B |
| | 28 day cut | | 0B | 4B |
| Alum. Untreated | | 1.38 | | |
| | 1 day cut | | 5B | 5B |
| | 7 day cut | | 4B | 5B |
| | 14 day cut | | 5B | 5B |
| | 28 day cut | | 5B | 5B |
| Alum. Treated | | 1.45 | | |
| | 1 day cut | | 5B | 5B |
| | 7 day cut | | 5B | 5B |
| | 14 day cut | | 5B | 5B |
| | 28 day cut | | 5B | 5B |

### Wet Adhesion:

| | | 4.63 g/w | 10.77 g/w |
|---|---|---|---|
| | | x-hatch | x-hatch |
| B952 | 4 days in CC | 4B | 0B |
| B1000 | 4 days in CC | 4B | 3B |
| Cold Roll Steel | 4 days in CC | 1B | 0B |
| Alum. Untreated | 4 days in CC | 5B | 5B |
| Alum. Treated | 4 days in CC | 5B | 5B |

### Salt Fog:

| | | | | | | | | | |
|---|---|---|---|---|---|---|---|---|---|
| Panel 1 | 114 Hrs. | 200 Hrs | 300 Hrs | 500 Hrs | Panel 2 | 114 Hrs. | 200 Hrs | 300 Hrs | 500 Hrs |

(B952)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the | 8D | 4M | 4D | 2D | 8D | 4M | 4D | 2D |
| scribe | | | | | | | | |
| Rusting on the scribe | 10 | 6 | 3 | 0 | 10 | 6 | 3 | 0 |
| Unscribed: | | | | | | | | |
| Rusting in the field | 10 | 10 | 10 | 10 | 10 | 10 | 10 | 10 |
| Blistering in the field | None | None | None | None | None | None | None | None |

(B1000)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the | 8F | 4M | 4D | 2D | 8F | 4M | 4D | 2D |
| scribe | | | | | | | | |
| Rusting on the scribe | 10 | 6 | 3 | 2 | 10 | 6 | 3 | 2 |
| Unscribed: | | | | | | | | |
| Rusting in the field | 10 | 10 | 10 | 10 | 10 | 10 | 10 | 10 |
| Blistering in the field | None | None | None | None | None | None | None | None |

(CRS)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the | 4D | 2M | 4D | 2D | 4D | 2M | 4D | 2D |
| scribe | | | | | | | | |
| Rusting on the scribe | 5 | 4 | 2 | 0 | 5 | 4 | 2 | 0 |
| Unscribed: | | | | | | | | |
| Rusting in the field | 10 | 10 | 10 | 10 | 10 | 10 | 10 | 10 |
| Blistering in the field | None | None | None | None | None | None | None | None |

(Mill Finish)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the | None | None | None | None | None | None | None | None |
| scribe | | | | | | | | |
| Rusting on the scribe | 10 | 10 | 10 | 10 | 10 | 10 | 10 | 10 |
| Unscribed: | | | | | | | | |
| Rusting in the field | 10 | 10 | 10 | 10 | 10 | 10 | 10 | 10 |
| Blistering in the field | None | None | None | None | None | None | None | None |

(Chromate Finish)

| | | | | | | | | |
|---|---|---|---|---|---|---|---|---|
| Scribed: | | | | | | | | |
| Rusting in the field | 10 | 10 | 10 | 10 | 10 | 10 | 10 | 10 |
| Blistering in the field | None | None | None | None | None | None | None | None |
| Blistering on the | None | None | None | None | None | None | None | None |
| scribe | | | | | | | | |
| Rusting on the scribe | 10 | 10 | 10 | 10 | 10 | 10 | 10 | 10 |
| Unscribed: | | | | | | | | |
| Rusting in the field | 10 | 10 | 10 | 10 | 10 | 10 | 10 | 10 |
| Blistering in the field | None | None | None | None | None | None | None | None |

The present disclosure has been written with reference to certain exemplary, illustrative and non-limiting embodiments. However, it will be recognized by persons having ordinary skill in the art that various substitutions, modifications or combinations of any of the disclosed embodiments (or portions thereof) may be made without departing from the scope of the invention as defined solely by the claims. Thus, it is contemplated and understood that the present disclosure embraces additional embodiments not expressly set forth herein. Such embodiments may be obtained, for example, by combining, modifying, or reorganizing any of the disclosed steps, ingredients, constituents, components, elements, features, aspects, and the like, of the embodiments described herein, in any manner that persons having ordinary skill in the art may find useful. Thus, this disclosure is not limited by the description of the exemplary and illustrative embodiments, but rather solely by the claims.

What is claimed is:

1. A polyurea coating composition comprising the reaction product of:
an isocyanate-functional component (A) comprising:
a) an aliphatic isocyanate functional material; and
b) a cycloaliphatic isocyanate functional material; and
an isocyanate-reactive component (B) comprising at least one polyaspartic acid ester component.

2. The polyurea coating composition of claim 1, wherein the aliphatic isocyanate functional material comprises a reaction product of hexamethylene diisocyanate and a hydroxy-functional ether compound.

3. The polyurea coating composition of claim 1, wherein the aliphatic isocyanate functional material comprises an allophanate reaction product of hexamethylene diisocyanate and a hydroxy-functional ether compound.

4. The polyurea coating composition of claim 1, wherein the aliphatic isocyanate functional material comprises an allophanate reaction product of hexamethylene diisocyanate and a hydroxy-functional polyether.

5. The polyurea coating composition of claim 1, wherein the aliphatic isocyanate functional material comprises an allophanate reaction product of hexamethylene diisocyanate and a hydroxy-functional polyether prepared using DMC catalysis.

6. The polyurea coating composition of claim 1, wherein the aliphatic isocyanate functional material comprises an allophanate reaction product of hexamethylene diisocyanate and a hydroxy-functional ether compound, the aliphatic isocyanate functional material having an isocyanate functionality of at least 4, a glass transition temperature less than −40° C., and a % NCO less than 10%.

7. The polyurea coating composition of claim 1, wherein the cycloaliphatic isocyanate functional material comprises a reaction product of isophorone diisocyanate and a mono-functional alcohol.

8. The polyurea coating composition of claim 1, wherein the cycloaliphatic isocyanate functional material comprises an allophanate-modified isocyanurate trimer reaction product of isophorone diisocyanate and a mono-functional alcohol.

9. The polyurea coating composition of claim 1, wherein the cycloaliphatic isocyanate functional material comprises an allophanate-modified isocyanurate trimer reaction product of isophorone diisocyanate and a mono-functional alcohol selected from the group consisting of methanol, ethanol, n-propanol, isopropanol, butanol isomers, pentanol isomers, hexanol isomers, heptanol isomers, octanol isomers, nonanol isomers, decanol isomers, 2-ethylhexanol, trimethyl hexanol, cyclohexanol, fatty alcohols having 11 to 20 carbon atoms, vinyl alcohol, allyl alcohol, and combinations of any thereof.

10. The polyurea coating composition of claim 1, wherein the cycloaliphatic isocyanate functional material comprises a reaction product of isophorone diisocyanate and a mono-functional alcohol, the cycloaliphatic isocyanate functional material having an isocyanate functionality of at least 2.3, and a glass transition temperature between 25° C. and 65° C.

11. The polyurea coating composition of claim 1, wherein the weight ratio of the cycloaliphatic isocyanate functional material to the aliphatic isocyanate functional material is from about 95:5 to about 50:50.

12. The polyurea coating composition of claim 1, wherein the polyaspartic acid ester corresponds to the formula: 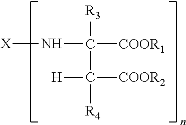
wherein
X represents an organic group which has a valency of n and is inert towards isocyanate groups at a temperature of 100° C. or less, preferably the group obtained, more preferably the hydrocarbon group obtained, by removing the amino groups from an aliphatic, araliphatic or cycloaliphatic polyamine, more preferably a diamine, and
R₁ and R₂ may be the same or different and represent organic groups which are inert towards isocyanate groups at a temperature of 100° C. or less, preferably an alkyl group containing 1 to 9 carbons and more preferably methyl, ethyl or butyl groups, or R₁ and R₂ together with the β-carbon atom form a cycloaliphatic or heterocyclic ring,
R₃ and R₄ may be identical or different and represent hydrogen or organic groups which are inert towards isocyanate groups at a temperature of 100° C. or less and
n has a value of at least 2, preferably 2 to 6, more preferably 2 to 4 and most preferably 2.

13. The polyurea coating composition of claim 1, wherein
X represents the hydrocarbon group obtained by removing the amino groups from an aliphatic, araliphatic or cycloaliphatic diamine,
R₁ and R₂ may be the same or different and represent methyl, ethyl or butyl groups,
R₃ and R₄ represent hydrogen, and
n has a value of 2.

14. The polyurea coating composition of claim 1, consisting essentially of the reaction product of:
an isocyanate-functional component (A) comprising:
a) an aliphatic isocyanate functional material; and
b) a cycloaliphatic isocyanate functional material; and
an isocyanate-reactive component (B) comprising at least one polyaspartic acid ester component.

15. The polyurea coating composition of claim 1, consisting of the reaction product of:
an isocyanate-functional component (A) comprising:
a) an aliphatic isocyanate functional material; and
b) a cycloaliphatic isocyanate functional material; and
an isocyanate-reactive component (B) comprising at least one polyaspartic acid ester component.

16. The polyurea coating composition of claim 1, wherein the equivalent ratio of NCO groups of the isocyanate (A) and the isocyanate reactive-groups of the isocyanate-reactive group component (B) is from about 20:1 to 1:20.

17. The polyurea coating composition of claim 1, wherein the equivalent ratio of NCO groups of the isocyanate (A) and the isocyanate reactive-groups of the isocyanate-reactive group component (B) is from about 10:1 to 1:10.

18. The polyurea coating composition of claim 1, wherein the equivalent ratio of NCO groups of the isocyanate (A) and the isocyanate reactive-groups of the isocyanate-reactive group component (B) is from about 5:1 to 1:5.

19. The polyurea coating composition of claim 1, wherein the equivalent ratio of NCO groups of the isocyanate (A) and the isocyanate reactive-groups of the isocyanate-reactive group component (B) is from about 3:1 to 1:3.

20. The polyurea coating composition of claim 1, wherein the equivalent ratio of NCO groups of the isocyanate (A) and the isocyanate reactive-groups of the isocyanate-reactive group component (B) is from about 2:1 to 1:2.

21. The polyurea coating composition of claim 1, wherein the equivalent ratio of NCO groups of the isocyanate (A) and the isocyanate reactive-groups of the isocyanate-reactive group component (B) is from about 1.5:1 to 1:1.5.

22. The polyurea coating composition of claim 1, wherein the equivalent ratio of NCO groups of the isocyanate (A) and the isocyanate reactive-groups of the isocyanate-reactive group component (B) is from about 1.2:1 to 1:1.2.

23. The polyurea coating composition of claim 1, wherein the equivalent ratio of NCO groups of the isocyanate (A) and the isocyanate reactive-groups of the isocyanate-reactive group component (B) is from about 1.1:1 to 1:1.1.

24. The polyurea coating composition of claim 1, wherein the equivalent ratio of NCO groups of the isocyanate (A) and the isocyanate reactive-groups of the isocyanate-reactive group component (B) is 1:1.

25. The polyurea coating composition of claim 1, wherein the isocyanate reactive-groups of the isocyanate-reactive group component (B) are —OH and —NH groups.

26. The polyurea coating composition of claim 1, wherein the isocyanate reactive-groups of the isocyanate-reactive group component (B) are exclusively —NH groups.

27. The polyurea coating composition of claim 22, wherein the polyaspartic acid ester is the only —NH functional compound.

28. A method of coating a metal substrate comprising applying the polyurea coating composition of claim 1 directly to the metal substrate and curing the polyurea coating composition.

29. The method of claim 24, wherein the metal substrate is new or weathered galvanized steel.

30. The method of claim 24, wherein the metal substrate is treated or untreated steel.

31. The method of claim 24, wherein the metal substrate is aluminum.

32. The method of claim 24, wherein the metal substrate is a metal alloy.

33. A substrate coated with the polyurea coating composition of claim 1.
